(19) United States
(12) Patent Application Publication
(10) Pub. No.: US 2015/0084335 A1
(43) Pub. Date: Mar. 26, 2015

(54) Pipe Coupling System and Methods of Use Thereof

(71) Applicants: Brian Farrell, Rio Rancho, NM (US); Ben Masefield, Albuquerque, NM (US)

(72) Inventors: Brian Farrell, Rio Rancho, NM (US); Ben Masefield, Albuquerque, NM (US)

(21) Appl. No.: 14/297,581

(22) Filed: Jun. 5, 2014

Related U.S. Application Data
(60) Provisional application No. 61/960,594, filed on Sep. 23, 2013.

(51) Int. Cl. F16L 19/06

(52) U.S. Cl. CPC F16L 19/06
USPC 285/343

(57) ABSTRACT

A pipe coupling system for joining a first pipe to a second pipe, the system having: a fitting having a first opening at a first end, a threaded portion, and an interior channel, the first opening capable of receiving the first pipe, a nut having a nut opening and a threaded portion, the nut opening capable of receiving the first pipe, and a sealing member having a seal opening, the sealing member capable of receiving the first pipe and being deformed by a compression force, the threaded portion of the nut capable of screwing onto the threaded portion of the fitting thereby applying a compression force onto the sealing member, the interior channel capable of receiving the sealing member, the sealing member capable of sealing a gap between the fitting and the first pipe and/or gripping the first pipe thereby securing the first pipe to the coupling system.

### CROSS-REFERENCE TO RELATED APPLICATION

This application claims the benefit of U.S. Provisional Application No. 61/960,594, filed on Sep. 23, 2013, which is incorporated herein by reference in its entirety.

### BACKGROUND

Pipe coupling is the practice of joining or coupling two or more pipes together or joining pipes to mating assemblies. Many fitting 100s used in pipe coupling require permanent engagement of the pipes and thus prevent the coupling system from being reused. Often fitting 100s are limited in applicability to pipes made of specific material and thus are unreliable and non-versatile when applied to multiple pipes made of different material.

### SUMMARY OF THE INVENTION

The present disclosure pertains to a coupling system for joining a first pipe to a mating member, said system having: a fitting having a first opening at a first end and a threaded portion, the first opening capable of receiving the first pipe, a nut having a nut opening and a threaded portion, the nut opening capable of receiving the first pipe, and a sealing member having a seal opening, the sealing member capable of receiving the first pipe, touching the first end of the fitting, and capable of being deformed by a compression force, the threaded portion of the nut capable of screwing onto the threaded portion of the fitting thereby applying a compression force onto the sealing member. One aspect of the disclosure is a coupling system where the mating member is a second pipe.

Another aspect of the disclosure is a coupling system where the sealing member applies an inward radial force onto the first pipe. Another aspect of the disclosure is a coupling system where the deformed sealing member seals a gap between the fitting and the first pipe. Another aspect of the disclosure is a coupling system where the deformed sealing member grips the first pipe thereby securing the first pipe to the coupling system.

Another aspect of the disclosure is the coupling system where the fitting further comprises an interior channel capable of receiving the sealing member. Another aspect of the disclosure is the coupling system where interior channel comprises a depth that allows for the top of the sealing member to protrude beyond the first end of the fitting when the sealing member is seated into the interior channel. Another aspect of the disclosure is the coupling system where the interior channel comprises a frustoconical shape. Another aspect of the disclosure is the coupling system where the fitting further comprises a collar and a seal stop, the collar and the seal stop defining the interior channel. Another aspect of the disclosure is the coupling system where the seal stop is tapered.

Another aspect of the disclosure is the coupling system where the fitting further comprises a pipe stop. Another aspect of the disclosure is the coupling system where the sealing member comprises a durometer level lower than the durometer level of the first pipe. Another aspect of the disclosure is the coupling system where the system further comprises a ring. Another aspect of the disclosure is the coupling system where the ring is positioned between the sealing member and the nut. Another aspect of the disclosure is the coupling system where the system further comprises a filament ring. Another aspect of the disclosure is the coupling system where the filament ring is positioned between the sealing member and the nut.

With those and other objects, advantages and features on the invention that may become hereinafter apparent, the nature of the invention may be more clearly understood by reference to the following detailed description of the invention, the appended claims, and the drawings attached hereto.

### BRIEF DESCRIPTION OF THE DRAWINGS

The accompanying drawings, which are incorporated herein and form part of the specification, illustrate various embodiments of the present invention and together with the description, further serve to explain the principles of the invention and to enable a person skilled in the pertinent art to make and use the invention. In the drawings, like reference numbers indicate identical or functionally similar elements. A more complete appreciation of the invention and many of the attendant advantages thereof will be readily obtained as the same becomes better understood by reference to the following detailed description when considered in connection with the accompanying drawings, wherein:

FIG. 1 is a perspective exploded view of a pipe coupling system according to an exemplary embodiment.

FIG. 2 is a perspective view of a pipe coupling system according to an exemplary embodiment.

FIG. 3 is a perspective view of a pipe coupling system according to an exemplary embodiment.

FIG. 4 is a perspective view of a pipe coupling system according to an exemplary embodiment.

FIG. 5 is a perspective view of a fitting according to an exemplary embodiment.

FIG. 6 is a top down view of a fitting according to an exemplary embodiment.

FIG. 7 is a side view of a fitting and a sealing member according to an exemplary embodiment.

FIG. 8 is a top down view of a fitting and a sealing member according to an exemplary embodiment.

FIG. 9 is a cross-sectional view of a pipe coupling system according to an exemplary embodiment.

FIG. 10 is a cross-sectional view of a pipe coupling system according to an exemplary embodiment.

FIG. 11 is a perspective view of a sealing member according to an exemplary embodiment.

FIG. 12 is a perspective exploded view of a pipe coupling system according to an exemplary embodiment.

### DETAILED DESCRIPTION

In the following detailed description, reference is made to the accompanying drawings which form a part hereof and in which is shown by way of illustration specific embodiments in which the invention may be practiced. These embodiments are described in sufficient detail to enable those skilled in the art to practice the invention, and it is to be understood that other embodiments may be utilized and that structural or logical changes may be made without departing from the scope of the present invention. The following detailed description is, therefore, not to be taken in a limiting sense, and the scope of the present invention is defined by the appended claims.

The present disclosure pertains to a pipe coupling system 10 for coupling a first pipe 20 to a mating member 30 where medium, for example, without limitation, liquid, gas, or the like, passes from the first pipe 20 to the mating member 30 via a passageway 110 within the pipe coupling system 10. The mating member can be any structure capable of mating to a fitting 100, for example, a pipe, pump, reservoir, flow meter, indicator, manifold, container, or the like. For exemplar purposes, this disclosure describes the mating member 30 as a pipe or second pipe, however, although the disclosure describes this and other exemplary embodiments, other embodiments are possible, and changes may be made to the embodiments described without departing from the spirit and scope of the invention.

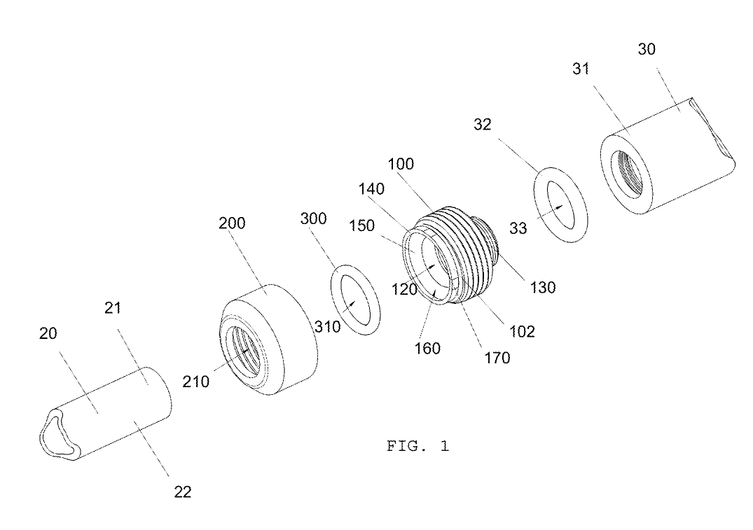

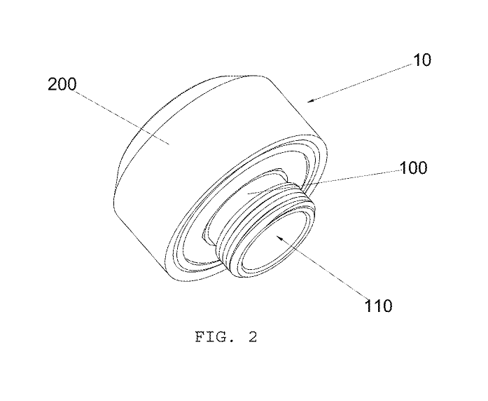

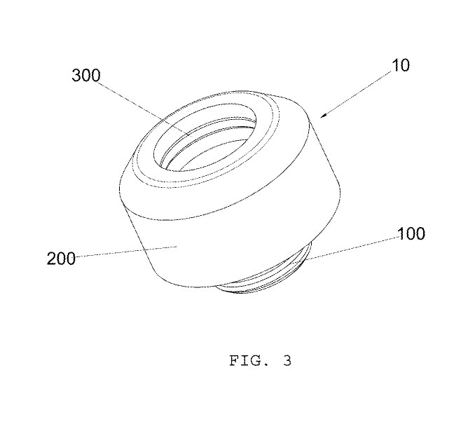

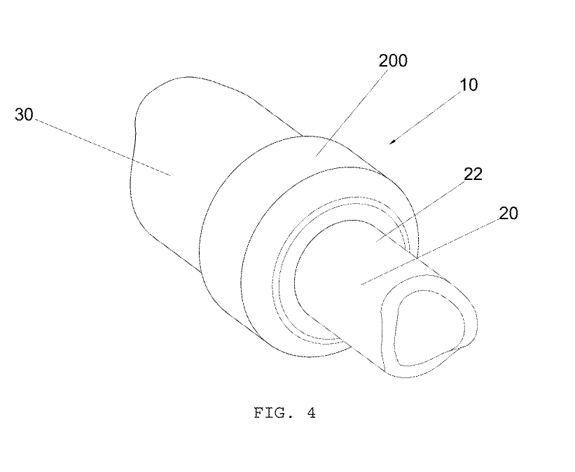

As shown in FIGS. 1-4, the pipe coupling system 10 can have a fitting 100, a nut 200, and a sealing member 300. In one embodiment, the pipe coupling system 10 seals or prevents medium from passing between the first pipe 20 and the pipe coupling system 10. The pipe coupling system 10 engages the first pipe 20. In one embodiment, the pipe coupling system 10 can engage the first pipe 20 and the second pipe 30. In one embodiment, the pipe coupling system 10 grips or secures the first pipe 20 thereby preventing the first pipe 20 from dislodging from the pipe coupling system 10.

The sealing member 300 can have the shape of a ring having a seal opening 310 capable of receiving the first pipe 20. The sealing member 300 can be an o-ring, gasket, or the like. In one embodiment, the sealing member 300 receives an end 21 of the first pipe 20 by way of the seal opening 310. The sealing member 300 can be made of any suitable soft elastic or semi-rigid material such as thermoplastic materials or curable elastomeric materials that allow for the sealing member 300 to be compressed. The term “elastomer” refers generally to a polymeric material that has rubberlike properties. More specifically, most elastomers have a significant amount of resilience or the ability to recover from an elastic deformation. Examples of elastomers include, without limitation, natural rubbers, polyisoprene, styrene butadiene rubber, chloroprene rubber, polybutadiene, nitrile rubber, butyl rubber, ethylene propylene rubber, ethylene propylene diene monomer, chlorosulfonated polyethylene, polysulfide rubber, polyurethane, and silicones.

The fitting 100 can be any type of pipe fitting, for example, without limitation, a coupler, adapter, reducer, elbow, tee, cross, cap, valve, or the like. For exemplar purposes, this disclosure will describe a pipe coupling system 10 utilizing a coupler, however, although the disclosure describes this and other exemplary embodiments, other embodiments are possible, and changes may be made to the embodiments described without departing from the spirit and scope of the invention.

In one embodiment, as shown in FIGS. 1, 5, 6, the fitting 100 can have a tubular shape defining a passageway 110, a first opening 120 at a first end 102, and a second opening 130 at a second end 104. The first opening 120 is capable of receiving the first pipe 20. In one embodiment, the first opening 120 receives the end 21 of the first pipe 20. At the first end 102, the exterior of the fitting 100 has a threaded section. In one embodiment, the first end 102 engages the end 21 of the first pipe 20 and the second end 104 engages the end 31 of the second pipe 30. The second end 31 can engage the second pipe 30 by any means in which a fitting 100 engages a pipe, for example, without limitation, by way of, male and female connectors, compression fitting, shrink fit, solvent welding, welding, soldering, brazing, adhesive, or the like.

The fitting 100 can be made of any material suitable for the intended purpose, for example, without limitation, plastic, nickel plated brass, stainless steel, copper, PTFE (Polytetrafluoroethylene), or the like.

Where the pipe coupling system 10 engages a second pipe 30, a second sealing member 32 can be utilized to seal between the second end 104 of the fitting 100 and the second pipe 30. The second sealing member 32 has a second seal hole 33 capable of receiving the second end 104 of the fitting 100. The second sealing member 32 can be an o-ring, gasket, or the like.

The nut 200 can have a threaded interior, for example, without limitation, a female threaded interior for receiving a male threaded exterior, for threadably receiving the threads on the first end 102 of the fitting 100. The nut 200 can have a nut opening 210 capable of receiving the first pipe 20. In one embodiment, the nut 200 receives an end 21 of the first pipe 20 by way of the nut opening 210.

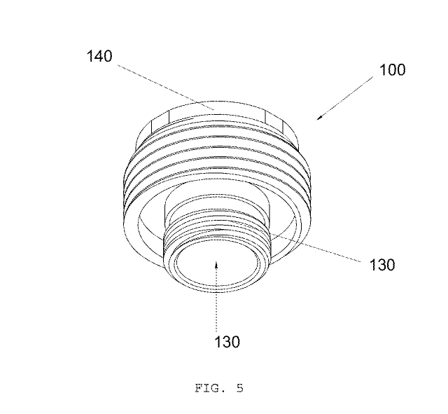

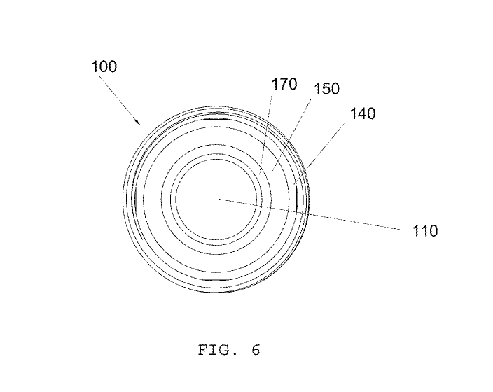

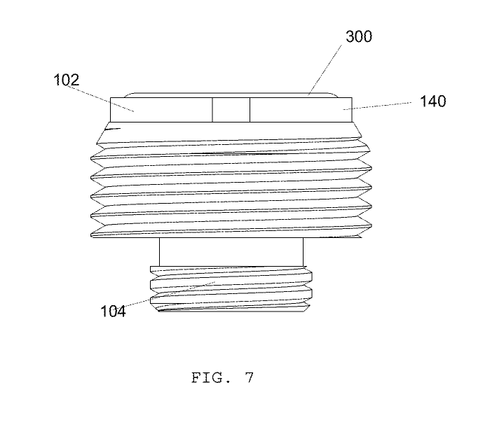

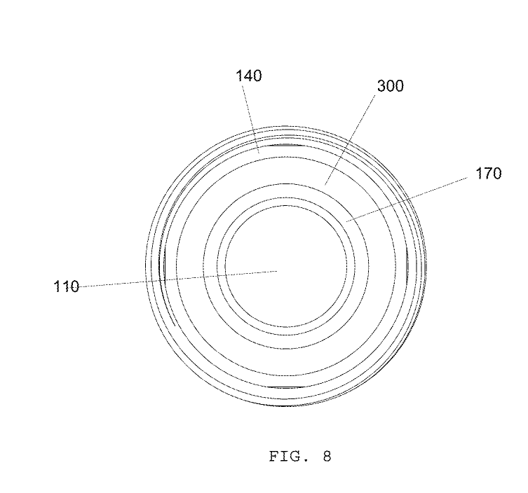

In one embodiment, as shown in FIGS. 5-6, the first end of the fitting 100 can have a collar 140 and a seal stop 150 that, when the first pipe 20 is received by the fitting 100, define an interior channel 160 positioned about the interior perimeter of the fitting 100. The interior channel 160 is capable of receiving the sealing member 300. The seal stop is capable of preventing the sealing member 200 from passing beyond a desirable distance through the fitting 100. In one embodiment, the seal stop 150 is tapered thereby allowing for the seal stop 150 to have a frustoconical shape. As show in FIGS. 7-8, the interior channel 160 has a depth that allows for the top of the sealing member 300 to protrude beyond the first end 102 of the fitting 100 when the sealing member 300 is seated into the interior channel 160.

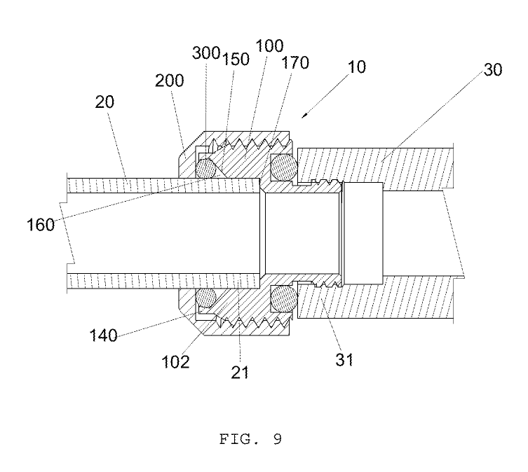

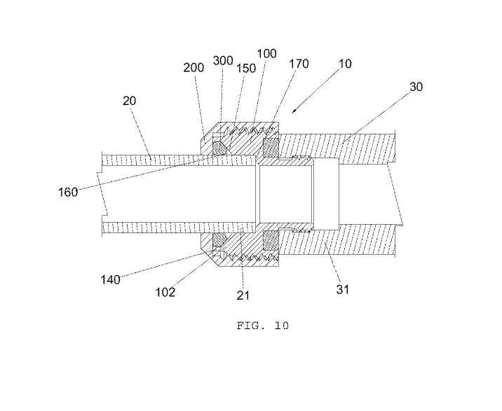

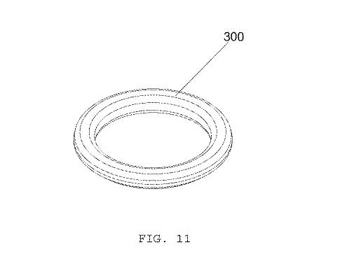

In one embodiment, the fitting 100 can have a pipe stop 170 for stopping the second pipe 30 from passing beyond a desirable distance through the fitting 100. While the pipe stop 170 can be any means for stopping a pipe in a fitting 100, the pipe stop 170 is preferably a ledge extending from the interior surface of the fitting 100 inwardly, as shown in FIG. 9. In one embodiment, the ledge has a circular shape extending the interior perimeter of the fitting 100. As shown in FIGS. 10-11, when the sealing member 300 is compressed by the nut 200, the portion of the sealing member 300 protruding beyond the first end 102 of the fitting 100 is compressed toward the second pipe 30 causing the sealing member 300 to be deformed. The deformation of the sealing member 300 causes a radial force to be exerted inward toward the longitudinal axis of the first pipe 20 and thus onto the exterior surface 22 of the first pipe 20. The deformation of the sealing member 300 causes any gap between the sealing member 300 and the exterior surface of the first pipe 20 to be closed. The radial force exerted onto the first pipe 20 is capable of creating a seal between the first pipe 20 and the pipe coupling system 10 thereby preventing medium from passing between the first pipe 20 and the pipe coupling system 10. In one embodiment, the radial force exerted onto the first pipe 20 is capable of securing the pipe coupling system 10 to the first pipe 20 by the pipe coupling system 10 gripping the first pipe 20 thereby preventing the first pipe 20 from easily dislodging, sliding, or being remove from the pipe coupling system 10.

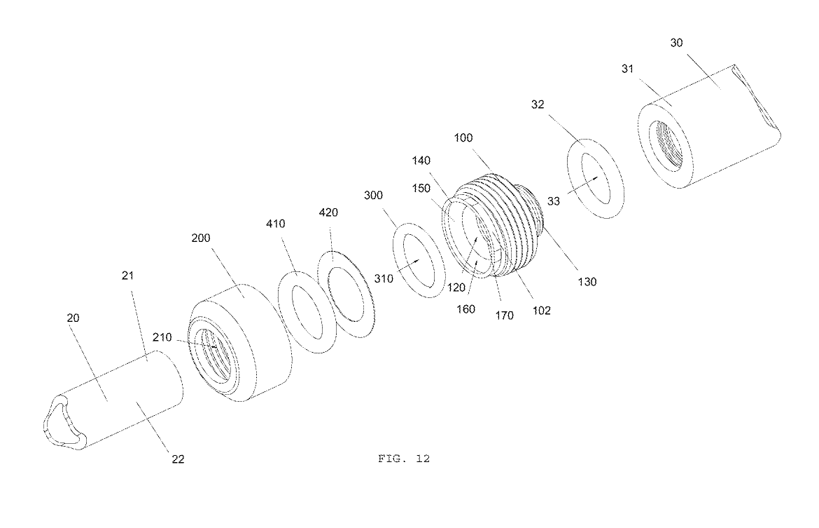

In one embodiment, as shown in FIG. 12, the pipe coupling system 10 can have a ring 410 for providing additional sealing capability of the pipe coupling system 10. The ring 410 can be positioned within the pipe coupling system 10 between the nut 200 and the sealing member 300. While the ring 410 can be any size, the exterior diameter of the ring 410 is substantially larger than the exterior diameter of the interior channel 160.

In one embodiment, as shown in FIG. 12, the pipe coupling system 10 can have a filament ring 420 for providing additional sealing capability of the pipe coupling system 10. The filament ring 420 can be positioned within the pipe coupling system 10 between the nut 300 and the sealing member 300, the ring 410 and the sealing member 300, the nut 300 and the ring 410, or the sealing member 300 and the fitting 100. While the filament ring 420 can be any size, the exterior diameter of the filament ring 420 is substantially larger than the exterior diameter of the interior channel 160.

The pipe coupling system 10 can be used in conjunction with a tube made of any type of rigid or semi-rigid material, for example, without limitation, tubes made of plastic material, such as ABS (Acrylonitrile butadiene styrene), ABS/PC (Acrylonitrile butadiene styrene/Polycarbonate blend), Acetal/POM (Polyoxymethylene), Acrylic, ETFE (Ethylene tetrafluoroethylene), EPDM (ethylene propylene diene monomer), EVA (Ethylene-Vinyl Acetate), FEP (Fluorinated ethylene propylene), MFA (Perfluoroalkoxy-methyl vinyl ether), Nylon, PEEK (Polyether ether ketone), PET (Polyethylene terephthalate), PETG (Polyethylene terephthalate, Copolymer), PFA (Perfluoroalkoxy alkane), PC (Polycarbonate), PE (Polyethylene) (LDPE (Low Density Polyethylene), HDPE (High Density Polyethylene), UHMWPE (Ultra High Molecular Weight Polyethylene)), PP (Polypropylene), PU (Polyurethane), PTFE (Polytetrafluoroethylene), PVC (Poly(vinyl chloride)), PVDF (Polyvinylidene fluoride), or THV (Tetrafluoroethylene)), metal material, such as, aluminum, steel, iron, stainless steel, nickel, nickel plated, titanium, copper, brass, bronze, lead, tin, zinc, bismuth, indium, or alloys, ceramics and crystalline solids such as glass, glass-mica, boron nitride, alumina, or silicates, the like, or any combination thereof.

In one embodiment, the radiant inward force applied by the sealing member 300 toward the surface of the first pipe 20 can be altered by altering the material of the sealing member 300. Where the pipe coupling system 10 is used in conjunction with a pipe made of material with a low durometer level, for example, without limitation, glass, or the like, a sealing member 300 made of a low durometer level can be selected to ensure the sealing member 300 will deform and not damage or break the tube while compressing the sealing member 300.

As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. As used herein, the term “and/or” includes any and all combinations of one or more of the associated listed items.

The foregoing has described the principles, embodiments, and modes of operation of the present invention. However, the invention should not be construed as being limited to the particular embodiments described above, as they should be regarded as being illustrative and not as restrictive. It should be appreciated that variations may be made in those embodiments by those skilled in the art without departing from the scope of the present invention.

Modifications and variations of the present invention are possible in light of the above teachings. It is therefore to be understood that the invention may be practiced otherwise than as specifically described herein.

What is claimed is:

1. A coupling system for joining a first pipe to a mating member, said system comprising:
a fitting having a first opening at a first end and a threaded portion, the first opening capable of receiving the first pipe,
a nut having a nut opening and a threaded portion, the nut opening capable of receiving the first pipe, and
a sealing member having a seal opening, the sealing member capable of receiving the first pipe and being deformed by a compression force,
the threaded portion of the nut capable of screwing onto the threaded portion of the fitting thereby applying a compression force onto the sealing member.

2. The coupling system of claim 1, wherein the mating member is a second pipe.

3. The coupling system of claim 1, wherein the sealing member applies an inward radial force onto the first pipe.

4. The coupling system of claim 1, wherein the deformed sealing member seals a gap between the fitting and the first pipe.

5. The coupling system of claim 1, wherein the deformed sealing member grips the first pipe thereby securing the first pipe to the coupling system.

6. The coupling system of claim 1, wherein the fitting further comprises an interior channel capable of receiving the sealing member.

7. The coupling system of claim 6, wherein interior channel comprises a depth that allows for the top of the sealing member to protrude beyond the first end of the fitting when the sealing member is seated into the interior channel.

8. The coupling system of claim 6, wherein the interior channel comprises a frustoconical shape.

9. The coupling system of claim 6, wherein the fitting further comprises a collar and a seal stop, the collar and the seal stop defining the interior channel.

10. The coupling system of claim 9, wherein the seal stop is tapered.

11. The coupling system of claim 1, wherein the fitting further comprises a pipe stop.

12. The coupling system of claim 1, wherein the sealing member comprises a durometer level lower than the durometer level of the first pipe.

13. The coupling system of claim 1, wherein the system further comprises a ring.

14. The coupling system of claim 1, wherein the ring is positioned between the sealing member and the nut.

15. The coupling system of claim 1, wherein the system further comprises a filament ring.

16. The coupling system of claim 1, wherein the filament ring is positioned between the sealing member and the nut.
